(19) United States
(12) Patent Application Publication
(10) Pub. No.: US 2019/0311703 A1
(43) Pub. Date: Oct. 10, 2019

(54) ACOUSTIC TRAUMA SYSTEM FOR LARVAL FISH

(71) Applicant: WASHINGTON STATE UNIVERSITY, Pullman, WA (US)

(72) Inventors: Allison Coffin, Vancouver, WA (US); Phillip Michael Uribe, Vancouver, WA (US); Jie Xu, Chicago, IL (US); Zecong Fang, Portland, OR (US)

(21) Appl. No.: 16/375,271

(22) Filed: Apr. 4, 2019

Related U.S. Application Data
(60) Provisional application No. 62/652,556, filed on Apr. 4, 2018.

(51) Int. Cl. G10K 11/16; A61H 23/02; G10K 11/00

(52) U.S. Cl. CPC G10K 11/161; A61H 23/0236; A61H 2203/03; G10K 11/004; A61H 2203/02; A61H 23/0245

(57) ABSTRACT

Hair cells are exquisitely sensitive to auditory stimuli, but also to damage from a variety of sources including noise trauma and ototoxic drugs. Mammals cannot regenerate cochlear hair cells, while non-mammalian vertebrates exhibit robust regenerative capacity. To allow for the effective examination of this process disclosed herein is a design and method of utilizing a device capable of inducing acoustic trauma in the larval lateral line. The device uses ultrasonic transducers to induce cavitation wherein microbubbles form in the fluid medium inside the container. These bubbles oscillate and then implode, sending shockwaves into the fluid inside the well-plate containing the fish. The device emits a broadband signal with peak sound energy in the low-frequency range below 200 Hz, consistent with the response range of the larval lateral line.

### CROSS-REFERENCE TO RELATED APPLICATION(S)

The present application claims under 35 U.S.C. § 119, the priority benefit of U.S. Provisional Application No. 62/652,556, filed Apr. 4, 2018, entitled “Acoustic Trauma For Larva Fish,” of which is incorporated herein by reference in its entirety.

### GOVERNMENT INTERESTS

This invention was made with government support under Grant/Contract Numbers R21 DC015636, awarded by the National Institutes of Health. The government has certain rights in the invention.

### FIELD OF THE INVENTION

This invention generally relates to studying hearing loss via acoustic trauma. In particular, the embodiments herein are directed to an acoustic cavitation system and process for studying induced acoustic trauma resulting in hearing loss in mammals.

### BACKGROUND OF THE INVENTION

### Discussion of the Related Art

Noise-induced hearing loss (NIHL) is the most common cause of hearing loss and the second most common occupational illness in the United States (Bureau of Labor Statistics, 2006), wherein the effects of NIHL are comorbid with depression, social isolation, and functional decline. Noise exposure can lead to permanent hearing impairment as the result of damage to mechanosensory hair cells within the cochlea.

Despite identification of cell death cascades associated with acoustic trauma, there is a lack of information about damage onset and progression. Further, although many candidate protective targets have been identified in rodents, no FDA-approved therapy exists and target innovation has been slow as known and understood by those of ordinary skill in the art. Thorough characterization of the progression of hair cell degeneration following noise exposure would represent a major advancement toward understanding and preventing NIHL.

This goal necessitates the development of a more accessible platform wherein viable hair cells can be rapidly assessed in vivo. Overexposure to intense noise causes hair cell damage 1-14 days after exposure and results in permanent threshold shifts. A primary biochemical mechanism of noise-induced hair cell damage is overproduction of reactive oxygen species (ROS). Immediately following noise trauma, hair cells exhibit increased ROS production that persists up to 10 days. Antioxidant therapies reduce NIHL in rodent models, which is consistent with a ROS-mediated hair cell death mechanism. ROS overproduction can lead to apoptosis or regulated necrosis and bit processes have been observed in noise exposed hair. In contrast, acoustic trauma that only induces temporary threshold shifts does not result in direct hair cell loss. Exposure to moderately intense noise causes cochlear synaptopathy, often leading to accelerated age-related hearing loss. In humans, synaptopathy likely contributes to tinnitus, hyperacusis, and difficulty processing speech in noise. Neurotrophic therapies such as neurotrophin-3 and BDNF show promise in regenerating cochlear synapses after noise damage, but more studies are needed to understand mechanisms of synaptopathy and develop preventative therapies.

Accordingly, a need exists for a novel process and correlated system to study acoustic trauma aimed at preventing noise-induced hair cell damage. The apparatus/system/process disclosed herein uses cavitation resultant from dissolved gases in a fluid interacting with ultrasonic waves so as to result in beneficial oscillation of microbubbles. In particular, induced microbubbles reach a maximum size and implode, emitting broadband shockwaves. As a result, underwater acoustic stimulation produced by the cavitation specifically damages lateral line hair cells, as shown in, for example, larval Zebrafish, in a time- and intensity-dependent manner. Utilizing larval Zebrafish with the disclosed system herein provides a novel overall platform that is beneficial for understanding the timing of events in noise-damaged hair cells and for future high-throughput drug discovery. The embodiments herein address such a need.

### SUMMARY OF THE EMBODIMENTS

An aspect of the embodiments herein include an acoustic cavitation system for noise intensity and time induced trauma, further including: a container configured to hold a disposed fluid; a well plate, wherein the well plate is removeably disposed therein the fluid in whole or in part; one or more elastic wave generators coupled to the container; an ultrasonic generator coupled to the one or more elastic wave generators, wherein the ultrasonic generator as coupled to the one or more elastic wave generators are configured to provide cavitation within the fluid via a plurality of sound pressures/intensities peak-to-peak of up to 188 (1 μPa) via an incremental supplied voltage range of up to 1.7 volts, and wherein the sound pressures/intensities are over an exposure time of up to about 120 minutes; and a controller/processor configured to provide control of the acoustic cavitation system and for data analysis.

Another aspect includes an acoustic method for assessing noise intensity over time induced hearing loss trauma, includes: disposing a specimen in a fluid container; exposing the hair cells of the specimen to a cavitation, wherein the cavitation results from a plurality of sound pressures/intensities peak-to-peak of up to 188 (1 ∥Pa) via an incremental supplied voltage range of up to 1.7 volts; providing the plurality of sound pressures/intensities over a time range of up to about 120 minutes; and assessing induced hearing loss trauma of the hair cells over at least a 72-hour post-exposure time period.

As disclosed herein, cavitation specifically damages lateral line hair cells in an exposure time-, post-exposure time-, and intensity-dependent manner. The embodiments herein provided acoustic damage in the lateral line and larval saccule. The time course ofdamage and regeneration following cavitation exposure also demonstrated that maximum hair cell loss occurs 72 hrs post-exposure, and that significant regeneration occurs by 96 hrs post-exposure. Accordingly, the novel cavitation system disclosed herein represents an accessible in vivo model for accelerating understanding of acoustic trauma and developing protective therapies.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A shows an example novel cavitation system utilized herein.

FIG. 2A shows the sound pressure levels measured via hydrophone an indicates an increasing intensity with increasing input voltage.

FIG. 2B shows the peak amplitude of the well-plate acceleration increases linearly with input voltage while average envelope exhibits an increase.

FIG. 2C shows a Fast Fourier transform of the power spectrum produced by the cavitation device system disclosed herein wherein it shows the broadband energy within the low-frequency range.

FIG. 3A shows a fluorescent image of larval zebrafish not exposed to acoustic stimulation.

FIG. 3B shows a fluorescent image of larval zebrafish exposed to 1.7V of acoustic stimulation for 80 minutes with 72 hours post-cavitation.

FIG. 3C shows a fluorescent image of larval zebrafish exposed to 1.7V of acoustic stimulation for 80 minutes with 72 hours post-cavitation with FIG. 3C shown to depict the diversity of DASPEI fluorescent labeling observed to that of the image shown in FIG. 3B.

FIG. 3D Quantification of acoustic stimulation-induced hair cell loss. In particular, the figure shows fish exposed to 0.7 V showing no reduction in DASPEI labeling.

FIG. 3E Quantification of acoustic stimulation-induced hair cell loss. In particular, the figure shows fish exposed to 1.2 V of acoustic stimulation exhibiting the greatest reduction in DASPEI labeling after 80 min of exposure and 72 h post-exposure.

FIG. 3F Quantification of acoustic stimulation-induced hair cell loss. In particular, the figure shows 1.7 V of acoustic stimulation produces similar DASPEI reduction to 1.2 V, as shown in FIG. 3E.

FIG. 4A shows an unexposed acoustic stimulation fluorescent image.

FIG. 4B contrasts with FIG. 4A via an image of acoustically stimulated O2 neuromasts from myo6b:EGFP transgenic larval zebrafish.

FIG. 4C shows the reduction of hair cells in five anterior lateral lines neuromasts at 24 and 72 hours after being treated with 1.2V of cavitation. Asterisks indicate significant difference from age-matched unexposed controls (*p<0.05, **p<0.01, ***p<0.005, ****p<0.0001). Statistical analysis is shown in Table 1. N=10-12 animals per treatment, values are mean+/−SD.

FIG. 4D shows the reduction of hair cells in five anterior lateral lines neuromasts at 24 and 72 hours after being treated with 1.7V of cavitation. Asterisks indicate significant difference from age-matched unexposed controls (*p<0.05, **p<0.01, ***p<0.005, ****p<0.0001). Statistical analysis is shown in Table 1. N=10-12 animals per treatment, values are mean+/−SD.

FIG. 4E shows the reduction of hair cell number in the posterior lateral line neuromats p1 and p2 at 24 and 72 hours after being treated with 1.2V of cavitation. Asterisks indicate significant difference from age-matched unexposed controls (*p<0.05, **p<0.01, ***p<0.005, ****p<0.0001). Statistical analysis is shown in Table 1. N=10-12 animals per treatment, values are mean+/−SD.

FIG. 4F shows the reduction of hair cell number in the posterior lateral line neuromats pl and p2 at 24 and 72 hours after being treated with 1.7V of cavitation. Asterisks indicate significant difference from age-matched unexposed controls (*p<0.05, **p<0.01, ***p<0.005, ****p<0.0001). Statistical analysis is shown in Table 1. N=10-12 animals per treatment, values are mean+/−SD.

FIG. 5A shows ultrasonic cavitation results for exposure time-dependent reduction in saccular hair cells. In particular, the figure shows a fluorescent image of acoustically unexposed saccules from myo6b:GFP transgenic zebrafish

FIG. 5B shows ultrasonic cavitation results for exposure time-dependent reduction in saccular hair cells. In particular, the figure shows a fluorescent image of cavitation exposed saccules from myo6b:GFP transgenic zebrafish.

FIG. 5C shows ultrasonic cavitation results for exposure time-dependent reduction in saccular hair cells. In particular, the plot shows treatment with 1.7 V of acoustic stimulation for 120 min significantly reduces saccular hair cell number when assessed 72 h post-exposure (one-way ANOVA; exposure time: F(2,30)=11.89, p<0.0002). Asterisks indicate significant difference from unexposed age-matched control (****p<0.001). N=10-12 animals per treatment, values represent mean +/−SD.

FIG. 6A specifically shows unexposed neuromasts brightly labeled with FM 1-43FX, 72 hours afterwards.

FIG. 6B shows acoustically stimulated neuromasts (80′ exposure, zero hours post-exposure, @1.7 volts) brightly labeled with FM 1-43FX.

FIG. 6C also shows acoustically stimulated neuromasts (80′ exposure, 72 hours post-exposure, @1.7 volts) brightly labeled with FM 1-43FX.

FIG. 6D shows a plot of quantified FM 1-43FX fluorescence (normalized to hair cell number) not significantly different in unexposed control versus up to 72 h post-exposure suggesting that acoustic stimulation does not alter hair cell mechanotransduction (one-way ANOVA; post-exposure time: F(4,50)=4.001, p<0.0068). Acoustically-exposed fish exhibit highly variable FM 1-43FX loading.

FIG. 6E indicates hair cell survival is reduced 72 h after acoustic stimulation (one-way ANOVA; post-exposure time: F(4,43)=17.19,p<0.0001). Hair cells were labeled with anti-parvalbumin and quantified in fixed animals. Asterisks indicate significant difference from unexposed control (****p<0.001). N=8-12 animals per treatment and values represent mean +/−SD.

FIG. 7A shows 80 minutes of cavitation reduces Ribeye puncta and increases the frequency of orphaned Ribeye puncta. The figure in particular shows unexposed neuromasts, the presynaptic marker Ribeye b is often colocalized with the postsynaptic marker MAGUK.

FIG. 7B shows an image 72 hours after cavitation of many orphaned Ribeye b puncta being present (white arrows). Hair cells are labeled with DAPI.

FIG. 7C also shows an image 72 hours after cavitation of many orphaned Ribeye b puncta being present (white arrows). Hair cells are labeled with DAPI.

FIG. 7D shows cavitation exposure significantly reduceing the number of synaptic ribbons per hair cell when assessed 72 hours after cavitation (t-test; p=0.0079).

FIG. 7E shows cavitation increasing the amount of synaptic ribbons lacking a neighboring MAGUK puncta (orphaned ribbons) (t-test; p=0.0004).

FIG. 8A shows TUNEL-positive hair cells increase 72 hours post-exposure to cavitation. The figure are representative images from unexposed control fish labeled with anti-parvalbumin and processed with the apoptotic maker TUNEL show no TUNEL+cells within the neuromas.

FIG. 8B shows images 72 h after noise exposure, TUNEL+hair cells are present within the IO1 neuromast (arrows).

FIG. 8C shows TUNEL+hair cells significantly increased over unexposed controls 72 h post-exposure recovery in IO1, IO2, and IO3 neuromasts (two-way ANOVA; post-exposure time: F(3,71)=12.09, p<0.0001; acoustic stimulation: F(1,71)=9.081, p<0.0036; interaction: F(3,71)=2.872, p<0.0423). Asterisks indicate significant difference from unexposed control (**p<0.01). N=7-12 fish pretreatment (three neuromasts per fish) and values represent mean +/−SD.

FIG. 8D shows TUNEL+parv−cells (non-hair cells, arrowhead) in unexposed and acoustic stimulation exposed fish are not significantly different over 72 h of recovery, suggesting that acoustic stimulation specifically damages hair cells (two-way ANOVA; post-exposure time: F(3,72)=21.91, p<0.0001; acoustic stimulation: F(1,72)=0.3405, p<0.5613; interaction: F(3,72)=1.345, p<0.2666). FIG. 8C shows a plot wherein TUNEL+hair cells are significantly increased over unexposed controls 72 hours post-exposure recovery (Two-way ANOVA; Post-exposure time: F(3,71)=12.09 p<0.0001; Cavitation: F(1,71)=9.081 p=0.0036; Interaction: F(3,71)=2.872 p=0.0423).

FIG. 8C shows TUNEL+supporting cells in unexposed and cavitation exposed fish are not significantly different over 72 hours of recovery.

FIG. 9 show acoustic cavitation-exposed fish exhibit complete hair cell regeneration. 80 minutes of 1.7V cavitation produces a reduction in DASPEI labeling by 72 hrs that is completely reversed by 96 hrs post-exposure.

FIG. 10 shows hair cells in the defective mechanotransduction mutant mariner line are resistant to cavitation damage. Unexposed F1 progeny from mariner heterozygotes exhibit DASPEI scores centered on 100%. Exposed F1fish are distributed in two distinct groups that are similar to the predicted Mendelian distribution, where roughly 25% of fish do not exhibit hair cell damage.

FIG. 11A shows Acoustic stimulation-induced hair cell damage is inhibited by protein synthesis and caspase inhibition. The figure shows a 4-h pulse with the protein synthesis inhibitor cycloheximide immediately after acoustic stimulation reduces hair cell damage when assessed 72 h after acoustic stimulation (two-way ANOVA; cycloheximide: F(3,83)=10.58, p<0.0001).

FIG. 11B shows Acoustic stimulation-induced hair cell damage is inhibited by protein synthesis and caspase inhibition. The figure shows 72-h treatment with the pan-caspase inhibitor Z-VAD starting immediately after acoustic stimulation exposure robustly protects hair cells from damage (two-way ANOVA; Z-VAD: F(2,64)=13.9, p<0.0001). Asterisks indicate significant difference from unexposed (0′, 0 M cycloheximide/Z-VAD) controls (**p<0.01, ****p<0.001). N=11-12 animals per treatment, values represent mean +/−SD.

FIG. 12A shows the treatment with antioxidants protects lateral line hair cells from cavitation. The figure shows 72 hour treatment with D-Methionine, an antioxidant that prevents NIHL in mammals, robustly protects lateral line hair cells from cavitation. (two-way ANOVA; D-methionine: F(2,69) =14.92, p <0.0001).

FIG. 12B shows a mini-screen of five antioxidants and the glutathione inhibitor buthionine sulfoximine (negative control) revealing novel hair cell protectants that have hair cell survival scores higher than vehicle (DMSO) control (one-way ANOVA; antioxidant: F(7,82)=12.28, p<0.0001). Asterisks indicate significant difference from unexposed, age-matched controls (A) and DMSO-only noise exposed controls (**p<0.01, ****p<0.001). N=11-13 fish per treatment, values represent mean +/−SD.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### General Description

As briefly stated above, a novel process and system is disclosed herein to study acoustic trauma in mammals, i.e., humans, via the incorporation of larval zebrafish as the platform. The system and process uses cavitation, which occurs when dissolved gases in a fluid interact with ultrasonic waves resulting in oscillation of microbubbles. Microbubbles reach a maximum size and implode, emitting broadband shockwaves. The embodiments herein provides underwater acoustic stimulation to affect and/or damage lateral line hair cells in a time- and intensity-dependent manner. The results herein also demonstrated that such affects/damage is prevented by antioxidant therapy. Moreover the timing of the events using the system disclosed herein provides insight into noise-damaged hair cells and enables high-throughput drug discovery studies aimed at preventing noise-induced hair cell damage.

All zebrafish experiments were approved by the Washington State University Institutional Animal Care and Use Committee. Larval fish were reared at 28.5° C. in petri dishes containing water from the WSU Vancouver fish facility (900-1000 μS and 7.0-7.2pH). Wild-type (*AB) were used for DASPEI hair cell assessment studies. Transgenic myo6b:GFP zebrafish were used for direct hair cell counts and FM 1-43 studies. The ty220d mariner mutant line was used for studies that tested the necessity of functional mechanotransduction (cells converting mechanical stimulus into electrochemical activity) on cavitation-induced hair cell damage.

### Specific Description

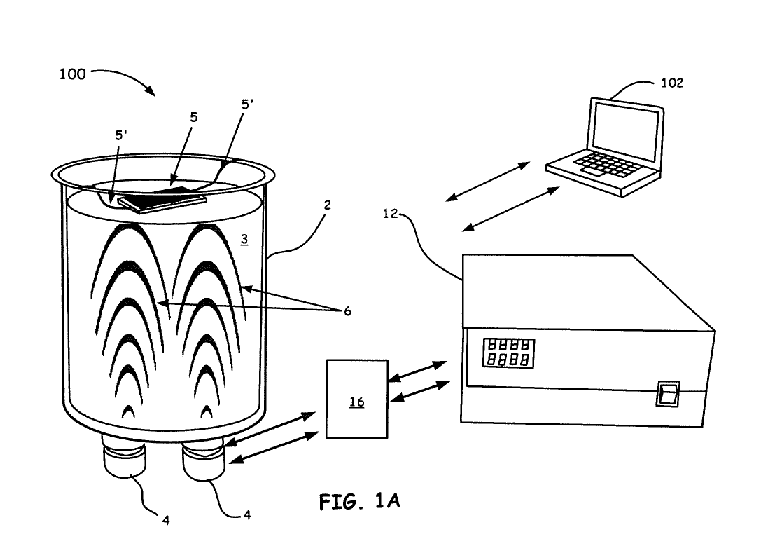

Turning now to the drawings, FIG. 1 shows a cavitation system, generally referenced by the numeral 100, for sound pressure and well plate acceleration. The novel system includes a container 2 configured to hold a disposed fluid 3, a plurality of elastic wave generators 4, (i.e., devices, often transducers that are capable of providing an elastic disturbance (e.g., sound waves 6) that can propagate in a solid, liquid, or gaseous medium), an elastic wave generator 12 and an in-line rheostat 16 each respectively coupled to the elastic wave generators 4 (as denoted by the double arrows) so as to provide ultrasonic induced waves in the fluid 3 having a broadband signal with peak sound energy in the low-frequency range (below 200 Hz), consistent with the response range of the larval lateral line. FIG. 1 also shows a custom well plate 5 configured with a holding means 5′ to enable the well plate (holding larval zebra fish (not detailed) to be disposed therein in whole or in part in the fluid 3, and a controller/processor 102 to aid a user in manipulating the system 100.

In the illustrated embodiment, the controller/processor 102 communicates with the system 100 (as also denoted by the double arrows). The controller/processor 102 can include a network server, a desktop computer, and/or other suitable computing devices of various circuitry of a known type, such as, but not limited to, by any one of or a combination of general or special-purpose processors (digital signal processor (DSP)), firmware, software, and/or hardware circuitry to provide instrument control, data analysis, etc., for the example configurations disclosed herein.

It is to be noted that in using such example computing devices, it is to also to be appreciated that as disclosed herein, the incorporated individual software modules, components, and routines may be a computer program, procedure, or process written as source code in C, C#, C++, Java, and/or other suitable programming languages. Image processing and data analysis often is done in MATLAB® and Origin®. The computer programs, procedures, or processes may be compiled into intermediate, object or machine code and presented for execution by any of the example suitable computing devices discussed above. Various implementations of the source, intermediate, and/or object code and associated data may be stored in one or more computer readable storage media that include read-only memory, random-access memory, magnetic disk storage media, optical storage media, flash memory devices, and/or other suitable media. A computer-readable medium, in accordance with aspects of the present invention, refers to media known and understood by those of ordinary skill in the art, which have encoded information provided in a form that can be read (i.e., scanned/sensed) by a machine/computer/processor and interpreted by the machine's/computer's/processor's hardware and/or software. It is also to be appreciated that as used herein, the term “computer readable storage medium” excludes propagated signals, per se.

As a working example embodiment, the system 100 often, but not necessarily includes up to about four electromechanical transducers as the elastic wave generators 4 that can provide up to about 40 kHz induced ultrasonic waves as coupled to the container 2. Such electromechanical transducers can often include ferroelectric (polymers) but more often piezoelectric transducers, and can also include transducer configurations, such as, angle beam transducers, immersion transducers, array transducers, etc. without departing from the spirit and scope of the invention.

While such elastic wave generators (hereinafter referred to as ultrasonic transducers 4) can be epoxy mounted to the bottom of the container 2, such as, but not limited to, a 3 1/32 gallon stainless steel canister as used herein, the coupling can also include index matching material/backing to effectively couple the sound generation to the container 2. Input power to the transducers was often provided by a 300 watt ultrasonic elastic wave generator 12 to produce the broadband (1 Hz up to about 40 kHz, often up to 20 kHz with peak sound energy in the low-frequency range (below 200 Hz)) noise stimulus. The inline rheostat 16, as shown in FIG. 1, was used to achieve finer control of power output. Fish (not detailed) were housed in a modified/custom 24-well plate 5 containing a 1 cm think layer of encased glycerol on the bottom.

The noise stimulus was calibrated using a mini-hydrophone (not shown) to measure sound pressure and a custom-modified triaxial accelerometer (not shown) to measure particle acceleration. During calibration, the hydrophone was position approximately 2.5 cm below the water surface at the position where the modified 24-well plate sits in the fluid 3, often water, column. The accelerometer was placed on the top surface of the well plate and held in position with clay. Calibrations measurements were made at four voltage outputs (0.5V, 0.7V, 1.0V, 1.7V) from the ultrasonic generator and measured in terms of sound pressure level (dB re: 1 μPa) and acceleration (dB re: 1 ms⁻²). The tri-axial accelerometer measurements in the x, y, and z axes were reported as a combined magnitude vector and calculated as 20 log ((x2+y2+z2)).

### Acoustic Trauma

At 5 days post-fertilization (dpf), fish were fed a light dusting of GEMMA micro 75 while in petri dishes. All noise exposure experiments were conducted at 6 dpf. Larval zebrafish were placed into wells A2-A5 and D2-D5 of a modified 24-well plate (3 fish per well) containing fish water and suspended atop 22 cm of water within the container 2 (stainless-steel canister) with the bottom of the 1 cm of the well plate 5 submerged (as generally shown in FIG. 1). While the well plate is disclosed often with the bottom of the plate being submerged, it is also to be understood that the entire well plate may be submerged without departing from the scope of the invention. Fish were exposed to cavitation for periods ranging from 20 to 120 minutes.

Immediately following cavitation fish were transferred to a 6-well plate 5 (6 fish per well) and kept in the fish facility on a 14 h light/10 h dark cycle for up to 5 post-exposure days. Each post-exposure morning (9-10 am) 50% of fish water was exchanged with fresh fish water and fish were lightly dusted with GEMMA food. Each post-exposure day evening (5-6 pm) fish were transferred to a fresh 6-well plate with completely fresh fish water.

### Hair Cell Assessment

Survival of lateral line hair cells was assessed by vital dye labeling in live fish and direct hair cells counts in live and fixed animals. The vital dye 2-(4-(dimethylamino)styryl)-N-ethylpyridinium iodide (DASPEI) is a marker of mitochondria membrane potential and stains lateral line hair cells. Fish were incubated in 0.005% DASPEI for 15 min, then rinsed twice with fish water and anesthetized with 0.001% MS-222. Using a Leica M165FC fluorescence dissection scope, 10 anterior neuromasts (IO1, IO2, IO3, IO4, M2, MI1, MI2, O2, SO1, and SO2) per fish were assessed based on fluorescent intensity. An intensity score of 2 signifies bright neuromast fluorescence, an intermediate score of 1 represents dim DASPEI labeling, while a 0 neuromast score equates to no neuromast fluorescence at a given neuromast's stereotyped position. The scores from 10 neuromasts per fish were summed such that each fish receives a score between 0 (no neuromast fluorescence) and 20 (full complement of hair cells in all 10 neuromasts).

Direct hair cell counts were obtained from live myo6b:EGFP transgenic larvae or fixed *AB and mariner mutant fish immunohistochemically labeled with anti-parvalbumin. To perform direct hair cell counts in non-transgenic animals, fish were euthanized with an overdose of MS-222 and fixed with 4% paraformaldehyde (PFA) overnight at 4° C. Fish were then rinsed twice with phosphate buffered saline (PBS) for 10 min each and then once with dH2O for 20 min. Larvae were then transferred to blocking solution consisting of 5% goat serum in PBST (0.1% Triton x-100) for 1 hour.

After blocking fish were incubated in mouse anti-parvalbumin (1:500) diluted in 0.1% PBST with 1% goat serum overnight at 4° C. Fish were then rinsed three times in 0.1% PBST and incubated for 4 hours in Alexa Fluor 488 secondary antibody diluted in 0.1% PBST at room temperature (RT). Unbound secondary was rinsed off by three 10 min 0.1% PBST rinses. Labeled fish were stored in 1:1 PBS: glycerol for up to a week prior to imaging.

To visualize synaptic proteins, fish were fixed in 4% PFA with 4% glycerol and 0.2mM CaCl2 for four hours at 4° C. Then fish were washed 3 times in PBS 10 min each then one 5 min wash with dH20 followed by a 10 minute wash in ice-cold acetone at −20° C. Larvae were blocked for 2 hours at RT in PBST (1% Tween-20) with 2% goat serum, 1% bovine serum albumin, and 1% DMSO. To label the post-synaptic density we used K28/86, which labels MAGUK proteins (1:500). The pre-synaptic ribbon protein Ribeye was labeled with either mouse monoclonal anti-Ribeye b (1:500) or rabbit polyclonal anti-Ribeye b (1:500). Then fish were washed 4 times with PBS at RT for 30 min each followed by incubation in either 488 or 568 Alexa Fluor secondary antibodies at 1:500 dilution overnight at 4° C. Fish were then PBS washed 4 times (30 min each) at RT, followed by a 10 min RT incubation in DAPI (1:1000) then stored at 4 ° C in 1:1 PBS:glycerol.

### Pharmacology

All inhibitors (to test roles of cell death (including apoptosis, pyroptosis and necroptosis) and inflammation, were added to 6-well plates immediately after cavitation-exposed fish were removed from the device. Inhibitors were refreshed during the same intervals as fish water (twice daily) until the end of the desired exposure window. To test the role of protein synthesis, fish were pulse treated immediately after acoustic trauma for 4 h with the protein synthesis inhibitor cycloheximide (C7698; Sigma Aldrich). In separate experiments, acoustic trauma-exposed fish were continuously treated with either the pan caspase inhibitor Z-VAD-FMK (C7698; Sigma Aldrich) or the antioxidant D-methionine (F7111; UBPBio) to assess the contribution of caspase activation and ROS overproduction, respectively, in the acoustically stimulated lateral line. A small blinded screen was also conducted of select compounds from a larger redox library (BML-2835-0100; Enzo Life Sciences). Compounds chosen had either known protective effects in mammalian models of NIHL (as proof-of concept) or had not been previously tested against NIHL (to identify new protective molecules).

### FM 1-43 Uptake

FM 1-43 uptake was quantified as a proxy for mechanosensitivity following cavitation exposure. Briefly, larval zebrafish were immersed in 3 μM FM 1-43 for 30 seconds followed by four 30 seconds washes in fish water. Fish were then immediately anesthetized with 0.001% MS-222 and imaged using confocal microscopy with a 40× water immersion objective. Z-stack images of M2 neuromasts were collected and compressed using Leica LAS AF software. Using ImageJ v. 1.48, mean neuromast fluorescence and background fluorescence were measured. Following live imaging of FM 1-43-labeled fish, larvae were fixed in 4% paraformaldehyde and labeled with anti-parvalbumin for hair cell quantification, as described above.

### Cell Death Assay

A TUNEL assay was used to label dying cells. Fish from various time points post-cavitation were fixed for 2 hours in 4% PFA at room temperature. Fish were then incubated in proteinase K (20 μg/mL) for 10 minutes followed by a 5 min PBS wash and 5 minutes in ice cold acetic acid:ethanol (1:2) at −20° C. After two 5 min PBS washes fish were exposed to 75 μL equilibrium buffer for 30 seconds followed by a 55 μL working strength TdT for one hour at 37° C. After 1 hour 1 mL of stop wash buffer was added followed by three 1 min PBS washes and 30 minutes in Anti-dig/block solution. Fish were then rinsed 4 more times with PBS, 2 min each, and then immunohistochemically processed with anti-parvalbumin as described above. Fish were imaged on a Leica SP8 confocal microscope. The number of TUNEL+/parv+cells per neuromast were quantified to determine the number of dyinghair cells. The number of TUNEL+/parv−cells were also quantified within a 50 μm×50 μm field of view surrounding the hair cells as a measure of cell death in non-sensory cells.

### Synaptic Protein Labeling

Pe- and postsynaptic proteins were labeled in acoustically exposed fish to assess synaptopathy following noise exposure. To label hair cell nuclei, live fish were treated with DAPI (1:1000 in system fish water) for 30 min. Following DAPI treatment, fish were immediately fixed in 4% PFA supplemented with 4% sucrose and 0.2 mM CaCl2 at 4° C. for 4 h. Fish were then rinsed three times in PBS for 10 mM each followed by a 5-min dH20 wash. They were then permeabilized with ice cold acetone for 10 min followed by a 5-min dH2O rinse. Fish were then transferred to blocking solution (0.1% Tween PBST, 1% DMSO, 1% BSA and, 2% goat serum) for 1 h at RT. After blocking, fish were incubated with primary antibodies against the postsynaptic density protein MAGUK (NeuroMab clone K28/86; 1:500) and the presynaptic ribbon synapse protein ribeye b (gift of T. Nicolson; 1:500) overnight at 4° C. Excess primary antibody was rinsed off with four 30-min PBS rinses. Finally, fish were incubated in Alexa Fluor antibodies (1:500) overnight at 4° C. Fish were imaged on a Leica SP8 confocal microscope. To count ribbons, the total number of ribeye b+ punctae were quantified. As a measure of “orphaned” ribbons not associated with a functional synapse, the number of ribeye b+ punctae were also quantified that were not apposed with the postsynaptic marker.

### Experimental Design and Statistical Analysis

All experiments used animals 6-11 dpf of either sex (sex cannot be determined at this age). Experiments used 8-16 fish per treatment group; animal numbers for each experiment are indicated respective figures associated with that experiment. Some experiments were performed blind to control for experimenter bias. Data were analyzed using GraphPad Prism (V. 6.0). Statistical analyses were performed using either an un-paired t test assuming equal variance, one-, or two-way ANOVA, as appropriate and as indicated in the figures to be detailed. Post hoc comparisons were performed using Bonferroni corrections.
Results

### Acoustic Output of the Cavitation System (100)

To stimulate the lateral line of larval zebrafish, the novel system 100 generally illustrated in FIG. 1 and as described above was used. While to be understood as non-limiting for the testing of the system, four 40-kHz ultrasonic transducers 4 were coupled to the bottom of a water-filled (fluid 3) of the container 2 (stainless steel tank), as shown in (FIG. 1). While the tank can be stainless steel, other materials, e.g., polymers, ceramics, etc. and the number of transducers 4 and types of transducers 4 can be utilized where warranted.

The transducers 4 were powered for this example arrangement, by a 300-W ultrasonic generator 12 with the aforementioned inline rheostat 16 that allowed for fine control of power output. During cavitation, zebrafish were housed in a custom 24-well plate 5 encased in glycerol (see FIG. 1).

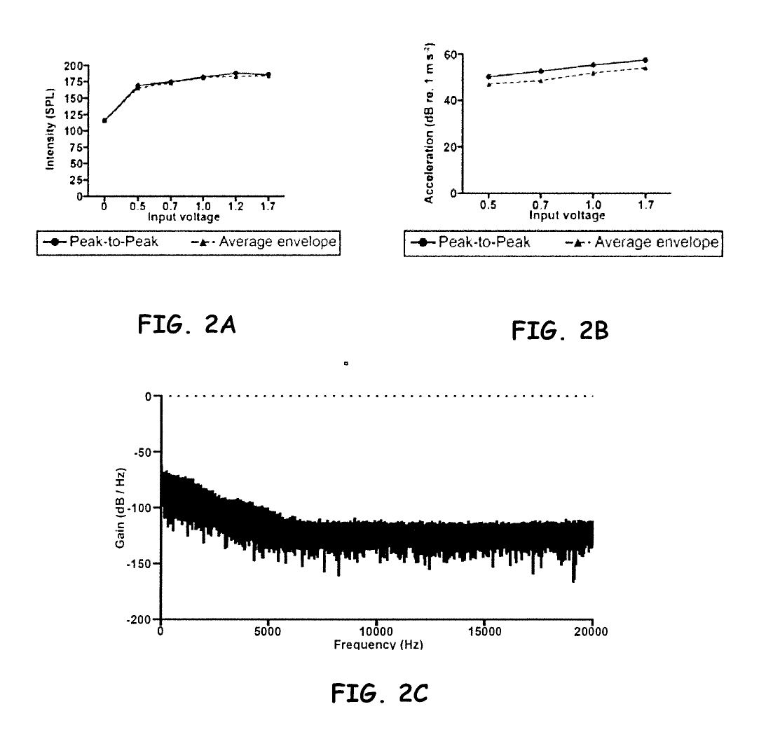

FIG. 2A shows sound pressure levels measured via hydrophone and indicates increasing intensity with increasing input voltage. FIG. 2B shows peak amplitude of well plate acceleration (measured from the top of the well plate) increases somewhat linearly with input voltage while average envelope exhibits a more modest increase and FIG. 2C shows a Fast Fourier transform of the power spectrum produced by the cavitation device system 100 wherein it shows broadband energy within the low-frequency range.

In particular, using a hydrophone, sound pressure was measured just beneath the surface of the water bath and found that both peak amplitude and average sound pressure envelope increase with input voltage up to an asymptote at 1.2V as shown in FIG. 2A. A custom well plate (e.g., a custom 24-well plate) encased in glycerol was constructed to house zebrafish during cavitation. Peak amplitude of acceleration, measured on top of the well-plate, increased in a steep linear fashion with voltage input while the increase in average envelope was more modest as seen in FIG. 2B. These results demonstrate that the cavitation device disclosed herein produces intense underwater sound pressure and well-plate acceleration that can be controlled by adjusting input voltage.

### Acoustic Stimulation Damages to Lateral Line Hair Cells

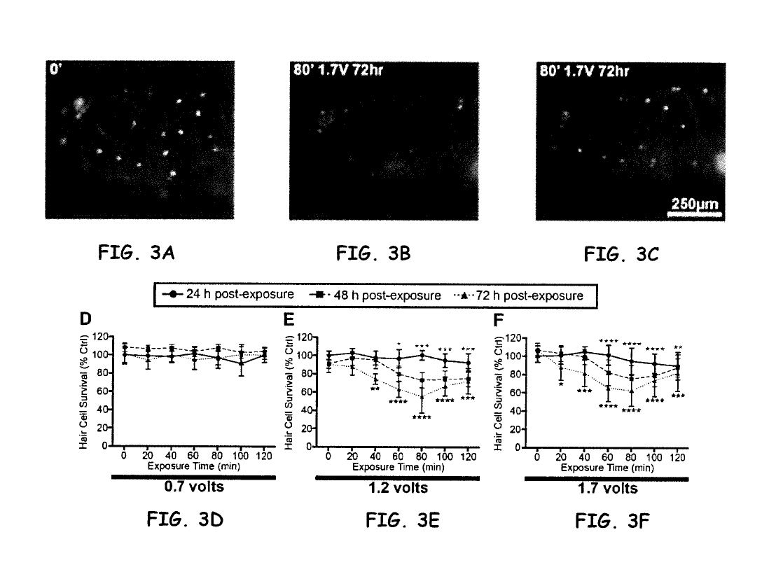

To assess the effects of acoustic stimulation on lateral line hair cell survival, zebrafish were exposed to acoustic stimulation and assessed hair cell survival via DASPEI staining, as shown in FIG. 3B and FIG. 3C. Unexposed controls labeled with the vital dye DASPEI display bright neuromast fluorescence indicative of intact hair cells as shown in FIG. 3A.

Fish exposed to acoustic stimulation at 1.7 V for 80 min exhibit dimmer DASPEI fluorescence than unexposed controls, indicating that acoustic stimulation reduces hair cell number (see FIG. 3B and FIG. 3C). Variability in hair cell damage is also indicated in the figures. For example, fish, as shown in images in FIG. 3B and FIG. 3C, were exposed to the same damage paradigm but exhibit different degrees of hair cell survival. Fish housed in the device for 8 h with no voltage input had DASPEI labeling consistent with unexposed controls at all post-exposure time points, indicating that handling and housing in the device does not contribute to the decreased DASPEI labeling seen in the acoustically-exposed larvae (data not shown).

For the lowest voltage tested (0.7 V, see FIG. 3D), acoustical stimulation up to 120 min resulted in no reduction of hair cell survival for any time points tested (also see Table 1 below). By contrast, 80 min of 1.2-V acoustic stimulation (see FIG. 3E) produced a 24% and 39% decrease in hair cell survival for post-exposure times of 48 and 72 h, respectively. Hair cell survival was lowest for 80 min of exposure and 72 h of post-exposure recovery time. Moreover, the acoustic stimulation induced at 1.7 V produced a similar degree of hair cell damage as that at 1.2 V (see FIG. 3F). For both 1.2- and 1.7-V driving voltages there was a gradual decline in hair cell survival with increasing exposure time up to 80 min. Interestingly and surprisingly, hair cell survival scores were consistently higher at 100and 120-min exposure times. This increased hair cell survival may be a result of earlier onset of hair cell death and subsequent regeneration.

TABLE 1
Statistical analysis of hair cell survival, as determined by DASPEI assessment

| Assessment method | Voltage | | Variable | F score | p value |
|---|---|---|---|---|---|
| DASPEI | 0.7 | V | Exposure time | F_{(12, 211)} = 1.54 | p = 0.2396 |
| | | | Recovery time | F_{(6, 211)} = 1.34 | p < 0.0001 |
| | | | Interaction | F_{(12, 211)} = 1.34 | p = 0.1131 |
| DASPEI | 1.2 | V | Exposure time | F_{(6, 216)} = 25.26 | p < 0.0001 |
| | | | Recovery time | F_{(2, 216)} = 144.0 | p < 0.0001 |
| | | | Interaction | F_{(12, 216)} = 6.23 | p < 0.0001 |
| DASPEI | 1.7 | V | Exposure time | F_{(6, 216)} = 19.72 | p < 0.0001 |
| | | | Recovery time | F_{(2, 216)} = 38.83 | p < 0.0001 |
| | | | Interaction | F_{(12, 216)} = 4.33 | p < 0.0001 |
| Hair cell counts | 1.2 | V aLL | Exposure time | F_{(2, 91)} = 13.39 | p < 0.0001 |
| | | | Recovery time | F_{(2, 91)} = 12.30 | p < 0.0001 |
| | | | Interaction | F_{(4, 91)} = 4.42 | p = 0.0026 |
| Hair cell counts | 1.7 | V aLL | Exposure time | F_{(2, 93)} = 10.87 | p < 0.0001 |
| | | | Recovery time | F_{(2, 93)} = 4.97 | p = 0.0089 |
| | | | Interaction | F_{(4, 93)} = 3.02 | p = 0.0217 |
| Hair cell counts | 1.2 | V pLL | Exposure time | F_{(2, 89)} = 4.90 | p = 0.0095 |
| | | | Recovery time | F_{(2, 89)} = 12.30 | p < 0.0001 |
| | | | Interaction | F_{(4, 89)} = 3.27 | p = 0.0151 |
| Hair cell counts | 1.7 | V pLL | Exposure time | F_{(2, 91)} = 9.85 | p = 0.0001 |
| | | | Recovery time | F_{(2, 91)} = 3.62 | p = 0.0308 |
| | | | Interaction | F_{(4, 91)} = 6.50 | p = 0.0001 |

All data were analyzed by two-way ANOVA.

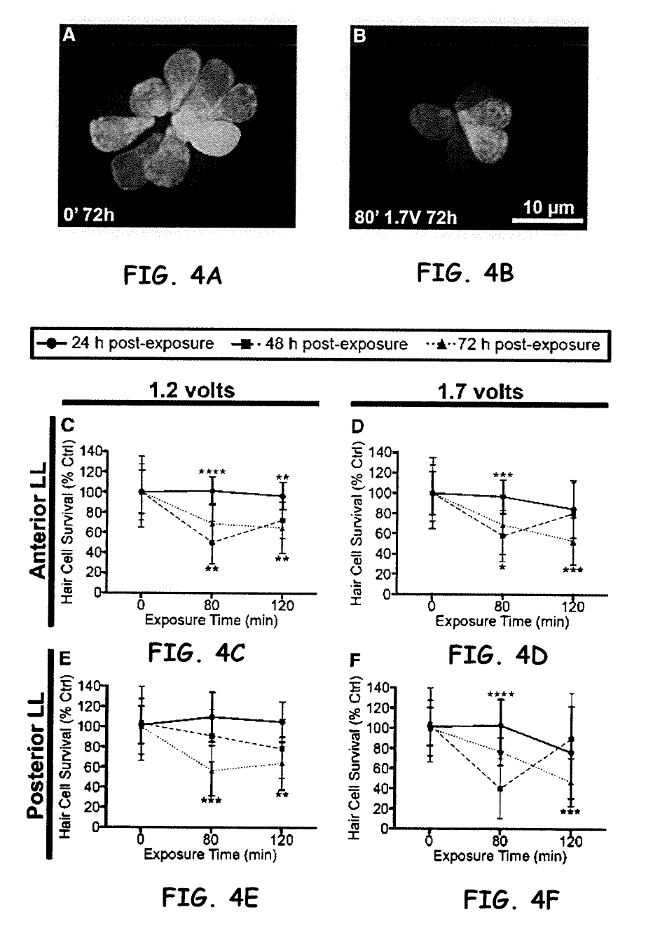

To validate DASPEI scores, transgenic myo6b:GFP fish were exposed to cavitation and obtained direct hair cell counts of GFP-positive cells following damage. Cavitation caused a significant loss of lateral line hair cells, consistent with the reduction in DASPEI fluorescence as illustrated in FIG. 4A, FIG. 4B, FIG. 4C, FIG. 4D, and FIG. 4F.

FIG. 4A and FIG. 4B fluorescent images reveal how acoustic stimulation decreases lateral line hair cell number. FIG. 4A in particular shows unexposed acoustic stimulation to contrast with FIG. 4B, i.e., acoustically stimulated 02 neuromasts from myo6b:EGFP transgenic larval zebrafish. The scale bar shown in FIG. 4B applies to both FIG. 4A and FIG. 4B. The acoustic stimulation induced at 1.2V cavitation reduced anterior lateral line hair cell survival at both 80- and 120-minute exposure times after either 48 or 72 hours post-exposure as seen in FIG. 4C. Exposure to 1.7V cavitation similarly reduced anterior lateral line hair cell survival as seen in FIG. 4D. The effect of cavitation was then determined on two posterior lateral line (pLL) neuromasts (p1 and p2) to determine if the cavitation effect is consistent across the lateral line system. Both 1.2V and 1.7V caused some damage in the pLL at 72 hours post-exposure as shown in FIG. 4E and FIG. 4F, suggesting that damage in the pLL may exhibit delayed onset of acoustic hair cell damage. Collectively. DASPEI and direct hair cell counts indicate that 1.2V or 1.7V cavitation results in robust hair cell damage when assessed 48 or 72 hours post-exposure.

### Acoustic Stimulation Damages Saccular Hair Cells

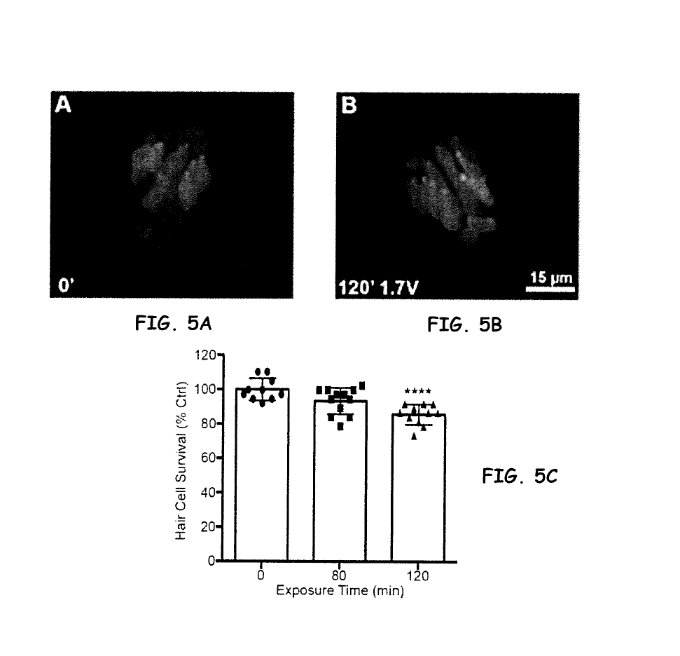

Adult zebrafish exposed to acoustic trauma exhibit hair cell damage within the saccule, the primary auditory end organ in fishes. However, Weberian ossicles, which couple the swim bladder to the ear and significantly broaden detectable frequency range, do not mature until ˜50 dpf, well past the age of the fish used in the present study. To determine if cavitation damages hair cells in the saccule of larval fish, myo6b:GFP fish t was exposed o 1.7V cavitation and assessed saccular hair cell number 72 hours after exposure. 120 minutes of 1.7V cavitation significantly reduced saccular hair cell density by 20% as seen in FIGS. 5A-5C. FIG. 5A shows ultrasonic cavitation results for exposure time-dependent reduction in saccular hair cells. In particular, the figure shows a fluorescent image of acoustically unexposed saccules from myo6b:GFP transgenic zebrafish. FIG. 5B shows ultrasonic cavitation results for exposure time-dependent reduction in saccular hair cells. In particular, the figure shows a fluorescent image of cavitation exposed saccules from myo6b:GFP transgenic zebrafish. FIG. 5C shows ultrasonic cavitation results for exposure time-dependent reduction in saccular hair cells. In particular, the plot shows treatment with 1.7 V of acoustic stimulation for 120 min significantly reduces saccular hair cell number when assessed 72 h post-exposure (one-way ANOVA; exposure time: F(2,30)=11.89, p<0.0002). Asterisks indicate significant difference from unexposed age-matched control (****p<0.001). N=10-12 animals per treatment, values represent mean +/−SD. This result demonstrates that cavitation damages saccular hair cells in the larval zebrafish even in the absence of Weberian ossicles.

### Acoustic Stimulation Does Not Alter FM 1-43 Loading

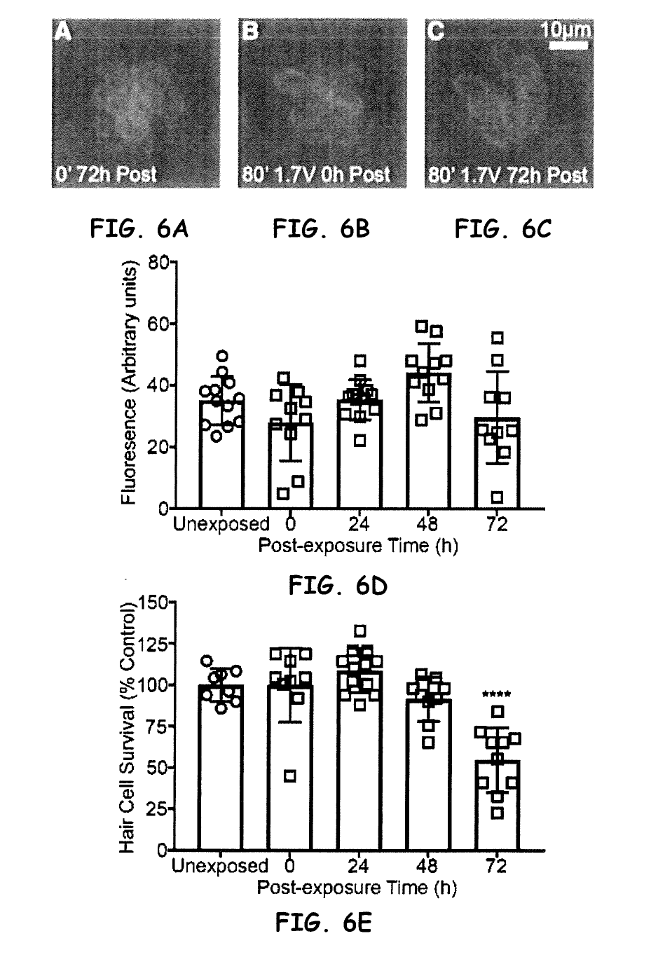

Hair cell tip links break (in Birds and Mammals) from prolonged (4-48 hrs) exposure to intense noise and rapidly regenerate within 48 hours. To test if cavitation results in damage to the mechanotransduction machinery loading of the mechanotransduction-dependent dye FM 1-43 was measured at different post-exposure time points. The FM 1-43 loading in cavitation-exposed hair cells is not significantly different from unexposed age-matched controls as seen in FIGS. 6A-6E.

In particular, such loading of the mechanotransduction dependent dye FM 1-43FX is not affected by acoustic stimulation in wild-type+AB zebrafish. FIG. 6A, FIG. 6B and FIG. 6C are representative images of neuromasts loaded with FM 1-43FX. FIG. 6A specifically shows unexposed while FIG. 6B and FIG. 6C show acoustically stimulated neuromasts brightly labeled with FM 1-43FX. FIG. 6D shows a plot of quantified FM 1-43FX fluorescence (normalized to hair cell number) not significantly different in unexposed control versus 72 h post-exposure suggesting that acoustic stimulation does not alter hair cell mechanotransduction (one-way ANOVA; post-exposure time: F(4,50)=4.001, p<0.0068). Acoustically-exposed fish exhibit highly variable FM 1-43FX loading. The plot of FIG. 6E indicates hair cell survival is reduced 72 h after acoustic stimulation (one-way ANOVA; post-exposure time: F(4,43)=17.19,p<0.0001). Hair cells were labeled with anti-parvalbumin and quantified in fixed animals. Asterisks indicate significant difference from unexposed control (****p<0.001). N=8-12 animals per treatment and values represent mean +/−SD.

Acoustic Stimulation Decreases Hair cell Synapse Number

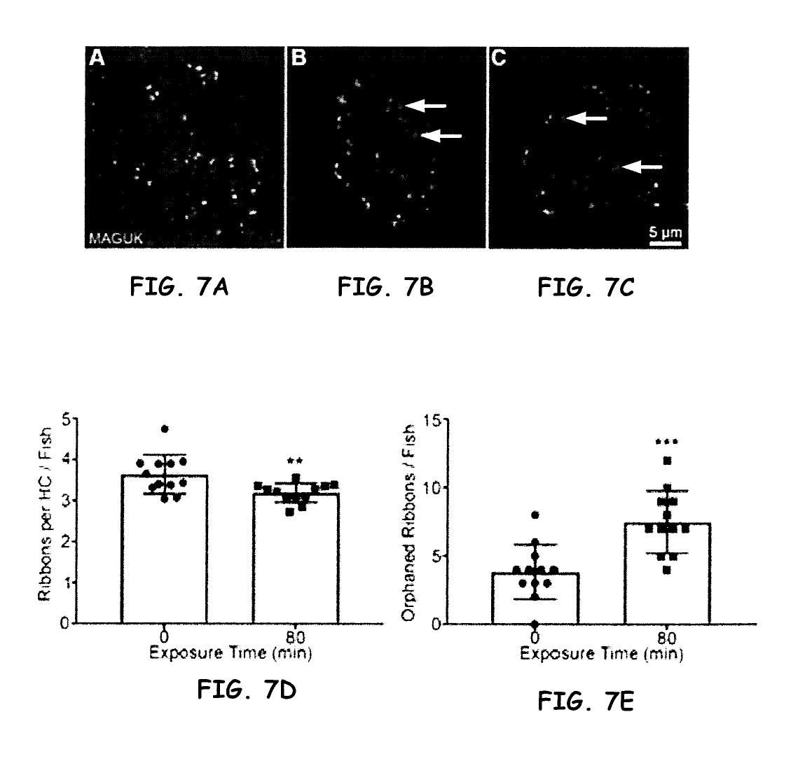

Cochlear hair cells exposed to moderate noise trauma exhibit a reduction in synaptic ribbons and an increase in orphaned ribbons that are unpaired with a post synaptic density. To test if acoustic stimulation leads to synaptopathy in the lateral line fish was labeled with DAPI, presynaptic (ribeye b), and postsynaptic (MAGUK) markers. Colocalization of ribeye b and MAGUK are indicative of synaptic contact. More orphaned ribeye b puncta (white arrows) are present in acoustically stimulated neuromasts than in unexposed controls (See FIGS. 7A-7E). In addition to reduced synaptic coupling, acoustic stimulation also caused a decrease in the number of presynaptic ribbons. Acoustic stimulation for 80 min decreased ribeye b puncta per hair cell when compared to unexposed controls at 72 h postexposure (FIG. 6D). Thus, acoustic stimulation causes a synaptopathic-like phenotype in the larval zebrafish lateral line.

### Onset of Acoustic Stimulation-Induced Hair Cell Death

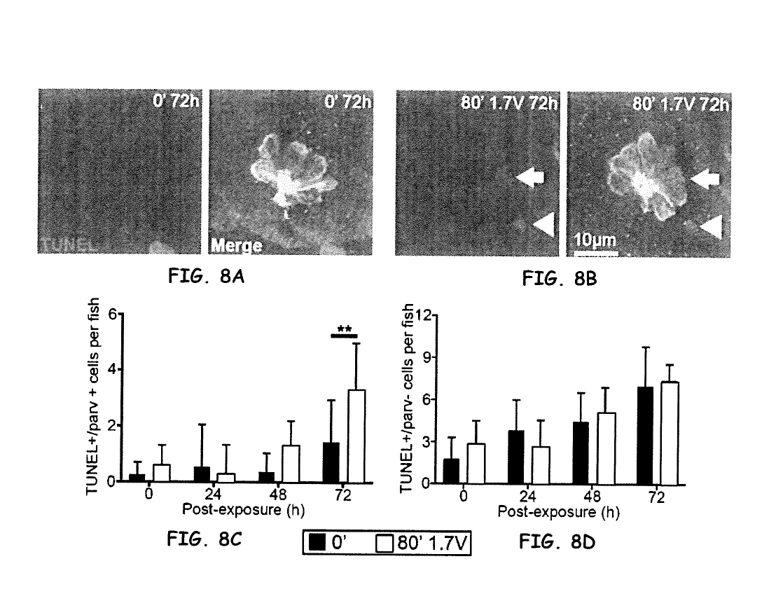

An observed maximum hair cell damage at 48 hours post-cavitation was shown in FIGS. 3A-3F and FIGS. 4A-4F, as discussed above. To determine the onset and specificity of acoustic trauma TUNEL and parvalbumin-labeled fish were examined at four post-exposure time points. Unexposed neuromasts had few TUNEL+hair cells, whereas 1.7 V of acoustic stimulation for 80 min resulted in a 128% increase in TUNEL+hair cells at 72 h post-exposure (see FIGS. 8A-D). The chosen post-exposure time points may not fully capture all dying cells, which may explain the lack of TUNEL+hair cells at 48 h postexposure similar between unexposed and exposed fish at all four post-exposure times points (FIG. 8D). These results demonstrate that hair cells are specifically damaged by acoustic stimulation whereas other non-sensory cell types exhibit similar TUNEL labeling to unexposed controls. Interestingly and surprisingly, TUNEL+non-sensory cells increase with post-exposure time in both exposed and unexposed fish, which may be due to cell death that has been observed during normal development.

Following damage with aminoglycosides, lateral line hair cells completely regenerate within 72 hours. Hair cell regeneration was also observed in the adult zebrafish saccule following acoustic trauma. The experiments were to address if larval lateral line hair cells regenerate following cavitation damage by assessing hair cell survival with DASPEI every 24 hours out to 120 hours post-cavitation.

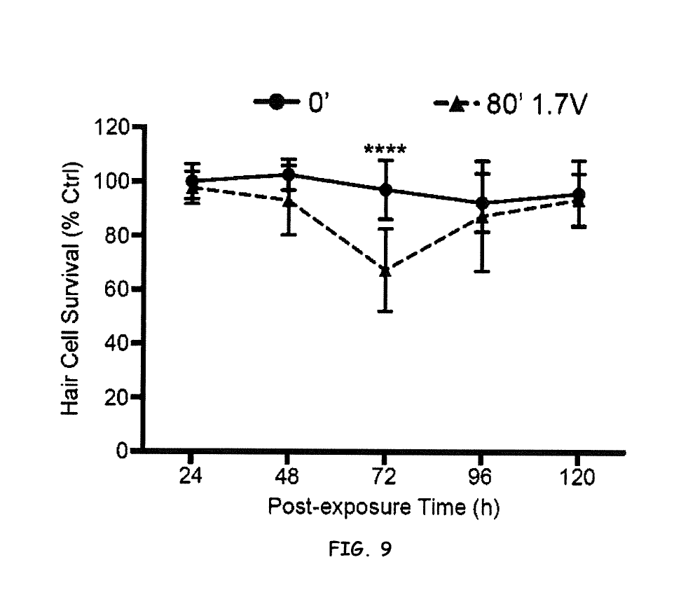

Following maximum damage at 72 hours post-exposure, hair cell survival scores return to the level of unexposed controls one day later as seen in FIG. 9. The extremely rapid regeneration may be accounted for by the staggered onset of hair cell loss, leading to staggered regeneration, unlike the synchronous damage that occurs from ototoxic drug exposure. This observation demonstrates that hair cells regenerate rapidly following cavitation in a timeframe consistent with regeneration from drug insults

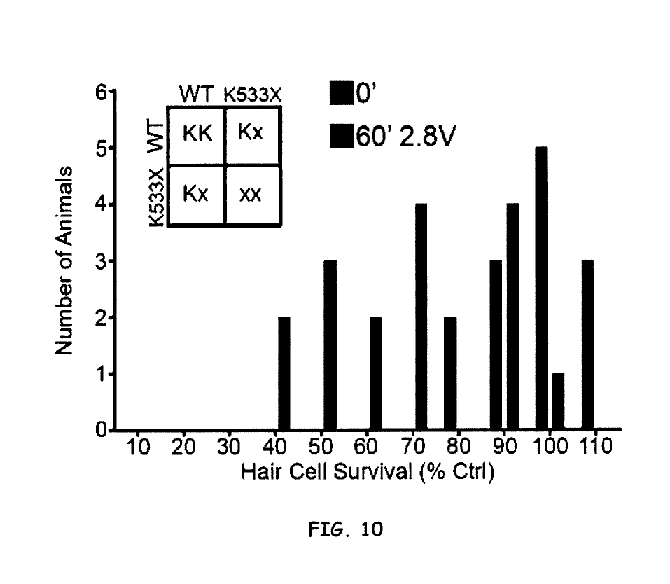

Mariner zebrafish have a defect in myosin VIIa due to a point mutation encoding a premature stop codon, resulting in splayed hair bundles and greatly reduced mechanotransduction. Mariner mutants exhibit reduced damage to aminoglycoside or cisplatin ototoxicity because these drugs rely on a functional mechanotransduction apparatus for uptake. F1 progeny were exposed from heterozygous mariner parents to cavitation to determine if cavitation damage was reliant on a functioning mechanotransduction apparatus. Hair cell survival scores for exposed F1 progeny were distributed in two distinct groups that match the predicted Mendelian distribution such that likely carriers of the homozygous mutant allele exhibited resistance to cavitation damage while siblings carrying at least one copy of the wild-type allele had reduced hair cell survival scores as seen in FIG. 10. From this result, it can be noted that cavitation damage is reliant on a functional mechanotransduction apparatus.

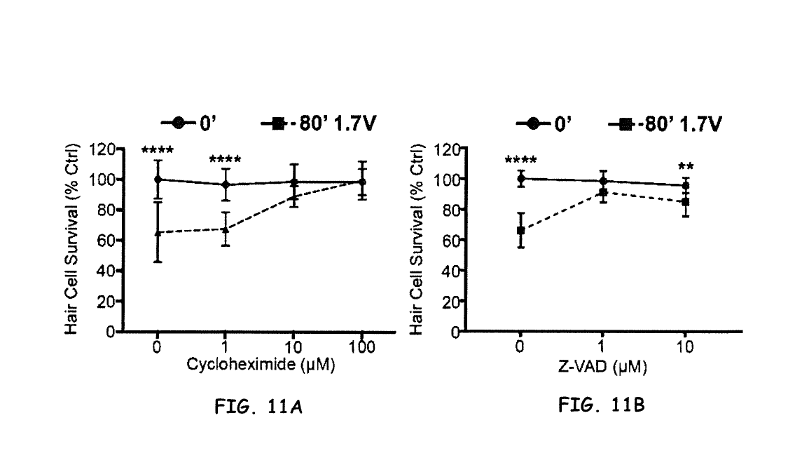

The relatively long-time course of cavitation-induced hair cell damage indicates that protein synthesis may be involved in damage. To test this hypothesis, fish was pulse treated with the protein synthesis inhibitor cycloheximide for four hours immediately following cavitation and assessed hair cell survival 72 hours post-exposure. Cycloheximide treatment protected lateral line hair cells from cavitation in a dose-dependent manner, demonstrating a reliance on protein synthesis for cavitation-induced hair cell damage as seen in FIG. 11A. Acoustic trauma can also result in activation of cell stress pathways that result in caspase activation, leading to hair cell apoptosis. Cochlear hair cells exposed to noise trauma positively label for activated caspases 3, 8, and 9 To test the reliance on caspase signaling in the cavitation damage model cavitation-exposed fish was treated with the pan caspase inhibitor Z-VAD for the entire 72-hour post-exposure window. Z-VAD treatment at 1 μM significantly reduced cavitation-induced hair cell damage as seen in FIG. 11B. These results suggest that cavitation-induced hair cell damage requires activation of intracellular signaling mechanisms.

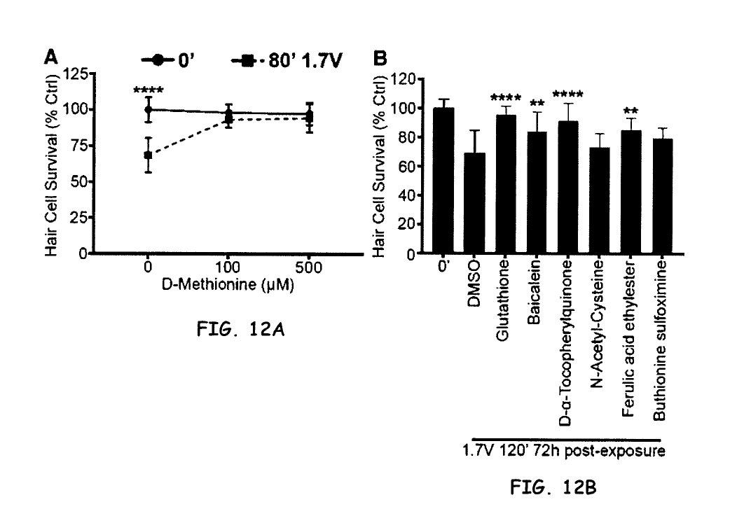

Surprisingly and unexpectedly the evidence demonstrates that oxidative stress occurs in hair cells exposed to acoustic trauma. Additionally, antioxidants represent one of the most studied classes of compounds as a preventative therapy for noise-induced hearing loss. To assess if similar mechanisms are present in cavitation exposed lateral line hair cells cavitation-exposed fish, such exposed fish were treated with the antioxidant D-methionine, which protects cochlear hair cells from acoustic injury. D-methionine treatment protected lateral line hair cells from cavitation damage at both 100 μM and 500 μM concentrations as seen in FIG. 12A.

Finally, the zebrafish lateral line was utilized as a tool to screen a select redox library for compounds that prevent cavitation-induced damage. Four compounds (glutathione, baicalein, d-α-tocopherylquinone, and ferulic acid ethylester) significantly protected lateral line hair cells from cavitation-induced hair cell damage as seen in FIG. 12B, only one of which (glutathione) has been previously identified as a potential therapy to prevent NIHL. The pro-oxidant compound buthionine sulfoximine did not confer protection. This result demonstrates the utility of cavitation-induced damage in the zebrafish lateral line to identify novel compounds that prevent acoustic hair cell damage.

Cavitation results in a reduction of ribeye b puncta and an increase in orphaned ribbons. Using the Mariner mechanotransduction mutants, it is noted that cavitation damage relies on an intact mechanotransduction apparatus. Cavitation results in TUNEL positive hair cells whereas other non-sensory cell types within the neuromast are unaffected, demonstrating that cavitation damage is specific to hair cells, rather than causing generalized cellular damage. The feasibility of employing our novel acoustic exposure platform for drug screening to identify compounds that prevent acoustic trauma-induced hair cell death.

Acoustic trauma studies in rodents have examined a range of exposure parameters and post-exposure assessment time points that vary based on the degree of desired damage and species (e.g., chinchilla vs. mouse). Most mammalian NIHL studies aimed at causing permanent threshold shifts use exposure times between 1 and 2 hours, with continuous exposure intensities between 100-120 dB SPL. 100 dB (1-2 hour exposure time) acoustic trauma resulted in modest hair cell loss (30% IHC loss, 50% OHC loss) whereas 110dB (4-8 hour exposure time) trauma resulted in 46% IHC loss and 96% OHC loss. Chinchillas exposed to 110 dB SPL acoustic trauma for 1 hour exhibit as much as 80% OHC loss in the mid basal region of the cochlea. In mammals, acoustic trauma results in progressive hair cell loss after cessation of noise, with maximum damage occurring 2 to 4 weeks post-exposure. The maximum hair cell damage occurred with exposure times of 80 to 120 minutes, similar to mammalian NIHL studies. However, in the lateral line, maximum damage was observed at post-exposure times of 48 to 72 hours, considerably, surprisingly and unexpectedly faster than the onset reported for acoustic trauma in mammals. Zebrafish rapidly regenerate damaged hair cells, which may mask assessment of ongoing damage past the 72-hour post-exposure time point. Using a hydrophone sound pressures peak-to-peak of 188 and 186 (1 μPa) for input voltages of 1.2 and 1.7 respectively was measured. The reported values correspond to sound pressure underwater (1 μPa) and when converted to air (20 μPa), accounting for difference in reference level, correspond to 126.5 and 128.5 dB SPL. These intensity values are similar to acoustic trauma intensities used to induce hair cell damage and permanent threshold shifts in rodent models. Further, these intensities can damage human hearing in as little as 15 minutes. Collectively, such a result indicates that hair cell sensitivity to acoustic trauma may be conserved across vertebrates.

Adult zebrafish exposed to a 100 Hz pure tone at 179 dB (1 μPa) for 36 hours exhibit as much as 43% hair cell loss in the caudal saccule whereas other regions are unaffected. Saccular hair cell loss occurred over the first 24 hours and was no longer detectable by 7 days post-exposure due to rapid hair cell regeneration. The results show that less saccular hair cell damage (14%) after just 120 minutes and 186 dB (1 μPa) broadband exposure. The differences in the degree of hair cell damage are likely to due to differences in exposure time, and to the absence of Weberian ossicles in larval fish. Weberian ossicles couple the swim bladder to the ear and first appear around 50 dpf. The presence of Weberian ossicles coincides with broadening of the detectable frequency range and lack of this coupling diminishes the fish's sensitivity to acoustic stimulation. The current study finds that, even in the absence of Weberian ossicles, saccular hair cells are damaged by intense acoustic trauma created by cavitation albeit to a lesser degree than the damage observed in adult saccule. The damage observed in larval fish coupled with the ability to image saccular and lateral line hair cells in intact, live preparations makes the larval zebrafish model of acoustic trauma a compelling model for future mechanistic studies.

The equal energy hypothesis postulates that noise-induced hearing loss is a product of noise intensity and exposure time. In rodent models, hair cell loss and damage increase as exposure intensity increases. As disclosed herein, intensity-dependent hair cell loss was demonstrated. However, hair cell loss reached an inflection point at 80 minutes of exposure. As the data revealed, for exposure times longer than 80 minutes, the onset of hair cell loss occurs more rapidly (<24 hr post-exposure) and thus initiates regeneration while cell death is still occurring within the neuromast masking the maximal effect. As methodology, employing a hair cell specific photo-convertable fluorescent protein (Tg(myo6b:NLS-Eos)) to differentiate hair cells that were present prior to cavitation from newly regenerated hair cells can be utilized.

Cleaved caspases 3, 8, and 9 are present in cochlear cells after acoustic trauma, and intracochlear perfusion of the pan caspase inhibitor Z-VAD reduces hair cell loss in guinea pigs following blast noise trauma. It was found that the pan-caspase inhibitor Z-VAD also reduced cavitation-induced lateral line hair cell damage, suggesting that reliance on caspase cleavage is conserved between rodent and zebrafish models of acoustic trauma. The delayed onset of hair cell damage following acoustic trauma implicates a role for transcription- and translation-mediated cell death. This hypothesis is difficult to test in rodents due to the high systemic toxicity of protein synthesis inhibitors limiting their use in rodents to in vitro studies.

Zebrafish offer the benefit of pulse treatment via bath applied inhibitors that can easily be rinsed out overcoming the downside of chronic toxicity. It was found that pulse treatment with cycloheximide for four hours after cavitation prevented hair cell loss when assessed 72 hours later, suggesting that acoustic trauma-induced hair cell damage relies on protein synthesis. These studies demonstrate the ability of the lateral line to elucidate mechanisms of acoustic trauma.

Acoustic trauma results in ROS and RNS overproduction in the cochlea that persists for up to 10 days. Many antioxidants and antioxidant cocktails have been reported to reduce NIHL in rodent models. For example, the antioxidant D-methionine protects cochlear hair cells in guinea pigs and mice from acoustic trauma. Following on the success of the rodent studies, a clinical trial using N-acetylcysteine to prevent NIHL had some promise but failed to meet clinical endpoints. It is noted that the embodiments herein disclose that D-methionine also protects lateral line hair cells from cavitation, again suggesting conserved mechanisms between the two models. To expand on this result the power of zebrafish was utilized in a phenotypic hair cell protection screen of a redox library and identified three novel protective antioxidants and confirmed one that had been previously identified in glutathione. Zebrafish have proven to be a productive tool in identifying compounds that prevent drug-induced hair cell death.

Compounds that prevent ototoxicity in zebrafish also translate to protection in mammalian models of ototoxicity. Additional novel compounds that prevent acoustic trauma-induced hair cell death can be studied using the disclosed system with the goal of developing compounds that prevent NIHL in humans. The discovery of cochlear synaptopathy transformed understanding of sound levels that were previously thought to be innocuous. The phenomenon of synaptopathy appears to be well conserved across species and has been observed in rodents, nonhuman primates, and humans. The characteristic phenotype of synaptopathy includes a decrease in ribbon synapse density and an increase in isolated ribbon synapses that lack a paired postsynaptic density. Zebrafish studies using direct application of AMPA suggest that this damage is mediated by calcium permeable AMPARs. As demonstrated, cavitation results in decreased ribeye b puncta and increased orphaned ribbons indicative of synaptopathy. The data shown herein are consistent with synaptic changes in noise-damaed cochlear hair cells and allow for future mechanistic dissection of synaptopathy using physiologically relevant stimuli.

It should be emphasized that the above-described embodiments and following specific examples of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An acoustic cavitation system for noise intensity and time induced trauma, comprising:
a container configured to hold a disposed fluid;
a well plate, wherein the well plate is removeably disposed therein the fluid in whole or in part;
one or more elastic wave generators coupled to the container;
an ultrasonic generator coupled to the one or more elastic wave generators, wherein the ultrasonic generator as coupled to the one or more elastic wave generators are configured to provide cavitation within the fluid via a plurality of sound pressures/intensities peak-to-peak of up to 188 (1 μPa) via an incremental supplied voltage range of up to 1.7 volts, and wherein the sound pressures/intensities are over an exposure time of up to about 120 minutes; and a controller/processor configured to provide control of the acoustic cavitation system and for data analysis.

2. The acoustic cavitation system of claim 1, wherein the sound pressures include a first sound pressure intensity peak-to-peak of 188 (1 μPa) for an input voltage of 1.2 volts and a second sound pressure intensity peak-to-peak of 186 (1 μPa) for an input voltage of 1.7 volts within the disposed fluid.

3. The acoustic cavitation system of claim 1, wherein the exposure time for the sound pressures is between 80 minutes up to about 120 minutes.

4. The acoustic cavitation system of claim 1, wherein the one or more elastic wave generators and the ultrasonic generator are configured to provide a peak sound energy in the low-frequency range below 200 Hz.

5. The acoustic cavitation system of claim 1, wherein the one or more elastic wave generators are configured transducers.

6. The acoustic cavitation system of claim 5, wherein the configured transducers are at least one of a ferroelectric transducer and a piezoelectric transducer.

7. The acoustic cavitation system of claim 5, wherein the configured transducers are at least one of an angle beam transducer, an immersion transducer, and an array transducer.

8. The acoustic cavitation system of claim 5, wherein the configured transducers are coupled to the base of the container.

9. An acoustic method for assessing noise intensity over time induced hearing loss trauma, comprising:
disposing a specimen in a fluid container;
exposing the hair cells of the specimen to a cavitation, wherein the cavitation results from a plurality of sound pressures/intensities peak-to-peak of up to 188 (1 μPa) via an incremental supplied voltage range of up to 1.7 volts;
providing the plurality of sound pressures/intensities over a time range of up to about 120 minutes; and
assessing induced hearing loss trauma of the hair cells over at least a 72-hour post-exposure time period.

10. The method of claim 9, further comprising treating the specimen with an antioxidant compound.

11. The method of claim 9, further comprising treating the specimen with at least one compound selected from: D-methionine, glutathione, baicalein, d-α-tocopherylquinone, and ferulic acid ethylester.

12. The method of claim 10, further comprising: treating with an inhibitor.

13. The method of claim 12, wherein the inhibitor is an inhibitor selected from: a protein synthesis inhibitor or a pan caspase inhibitor.

14. The method of claim 13, wherein the protein synthesis inhibitor is cycloheximide.

15. The method of claim 13, wherein the cavitation damages lateral line hair cells and larval saccule in the specimen.

16. The method of claim 9, further comprising: assessing the noise intensity over time induced hearing loss trauma with dye labeling.
